(19) United States
(12) Patent Application Publication
(10) Pub. No.: US 2007/0160753 A1
(43) Pub. Date: Jul. 12, 2007

(54) Method to encapsulate phosphor via chemical vapor deposition

(76) Inventors: Chen-Wen Fan, Sayre, PA (US); Chung-Nin Chau, Athens, PA (US); Gregory A. Marking, Sayre, PA (US); William F. Edgerton, New Albany, PA (US)

Correspondence Address: OSRAM SYLVANIA INC, 100 ENDICOTT STREET, DANVERS, MA, 01923, US

(21) Appl. No.: 10/555,337

(22) PCT Filed: May 13, 2004
(86) PCT No.: PCT/US04/14948

§ 371 Date: Oct. 10, 2006

Related U.S. Application Data
(60) Provisional application No. 60/470,635, filed on May 15, 2003.
(60) Provisional application No. 60/470,734, filed on May 15, 2003.

(51) Int. Cl. B05D 7/00

(52) U.S. Cl. 427/213

(57) ABSTRACT

The maintenance characteristics of the phosphors used in VUV-excited devices such as plasma display panels can be improved by applying a coating of an aluminum oxyhydroxide compound by reacting vaporized trimethylaluminum with water vapor at a temperature of about 430° C. or above. In particular, the maintenance of an europium-activated, calcium-substituted barium hexa-aluminate phosphor is significantly improved following exposure to a high intensity VUV flux.

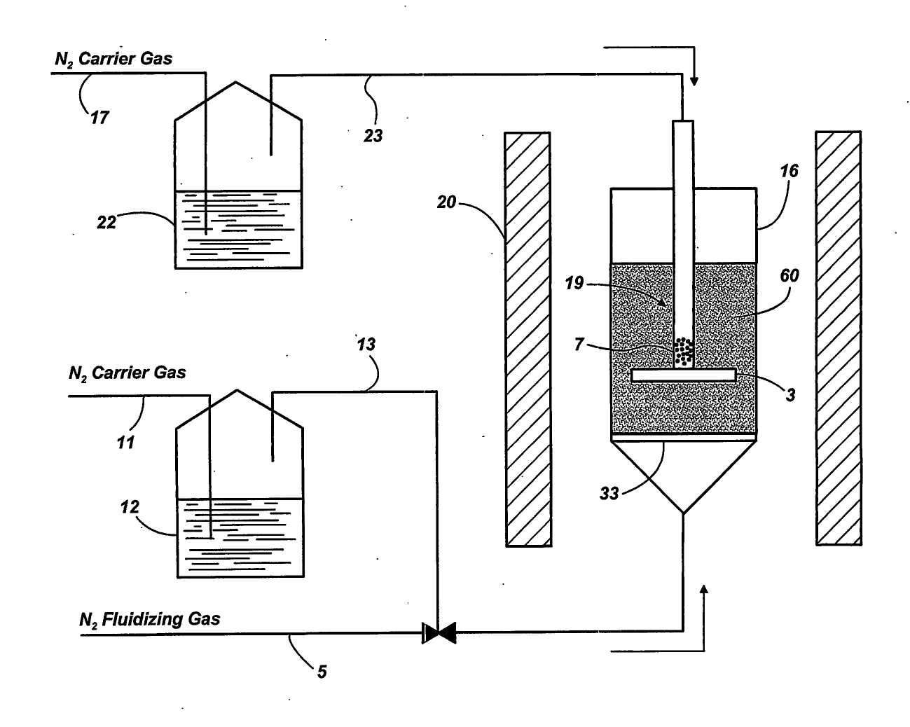

### CROSS REFERENCES TO RELATED APPLICATIONS

This application claims the benefit of U.S. Provisional Application Nos. 60/470,734 and 60/470,635, both filed May 15, 2003.

### TECHNICAL FIELD

This invention relates to a method of encapsulating phosphor particles for use in vacuum ultraviolet (VUV)-excited devices. In particular, this invention relates to methods for encapsulating phosphors in order to protect the phosphor particles from moisture attack, VUV radiation and Xe plasma bombardment.

### BACKGROUND OF THE INVENTION

Conventional plasma display panels and other vacuum ultraviolet (VUV)-excited devices are filled with rare gases or mixtures of rare gases (helium, neon, argon, xenon, and Lapton), which are excited by a high voltage electrical current and emit ultraviolet radiation in the VUV range below 200 nm wavelength. This emitted VUV radiation is then used to excite various blue-, green-, and red-emitting phosphors. These phosphors differ from those typically used in conventional fluorescent lamps in that they are excited by high energy vacuum ultraviolet photons with wavelengths less than 200 nm while the conventional fluorescent lamp excitation energy is primarily the lower energy 254 nm emission from mercury vapor. Currently, the most common VUV excitation energy comes from xenon or xenon-helium plasmas, which emit in the region from 147 nm to 173 nm, with the exact emission spectra depending on the Xe concentration and overall gas composition. Under high voltage excitation, Xe-based plasmas typically have a Xe emission line at 147 nm and a Xe excimer band emission around 173 nm. The large difference in excitation energies between vacuum ultraviolet and conventional short-wave ultraviolet fluorescent applications impose new requirements on the phosphors used for VUV-excited display panels or lamps. Furthermore, differences in the manufacturing processes used for VUV-excited and conventional fluorescent devices also impose new requirements on the phosphors.

In general, the VUV-excited phosphors used to emit all three colors (red, green, and blue), exhibit some undesirable properties, but the phosphor commonly used as the blue emitter, Ba₁₋ₓEuₓMgAl₁₀O₁₇ (0.01<x<0.20) or BAM, is most problematic. This phosphor is known to degrade in both brightness and color during the manufacturing process due to elevated temperatures and humidity. This phosphor also degrades in both brightness and color after extended exposure to a high intensity Xe plasma and VUV photon flux. Degradation mechanisms of BAM are the subject of much study and are thought to involve such changes as oxidation of Eu²⁺ to Eu³⁺, modifications in the actual structure of the aluminate phosphor lattice, and movement of the Eu²⁺ activator ions between different sites within the lattice. The useful lifetime of a commercial plasma display panel is unacceptably short due to the shift in color and reduction in intensity of the blue phosphor component, which leads to an undesirable yellow shift in the overall panel color. The most relevant measure of this degradation is the maintenance of the ratio of the intensity (I) to the CIE y color point, I/y. Both the intensity decrease due to degradation and the increase in CIE y color coordinate result in a reduction of the I/y ratio.

In recent years, a number of different approaches have been attempted in order to improve the maintenance of blue VUV-excited phosphors. These approaches include sol-gel coating of wide bandgap metal oxides onto BAM phosphor, thermal treatments of aluminate phosphors mixed with ammonium fluorides, solution based catena-polyphosphate coatings of BAM phosphor, substitution of alkali metals, alkaline earth metals, or zinc into the BAM stoichiometry, and preparation of a solid solution BAM-barium hexa-aluminate (0.82 BaO.6Al₂O₃) phase, which exhibits improved color stability and maintenance but has an undesirable color point. Additionally, new phosphors with improved maintenance characteristics have been investigated such as (La_{1-x-y-z}TmₓLi_{y}Sr_{z})PO₄, Ba₁₋ₐEuₐMgAl₆O₁₁, CaMgSi₂O₆:Eu²⁺; and CaAl₂O₄:Eu²⁺.

Although many of these phosphors or phosphor complexes exhibit improvements in color and intensity stability, none have yet proven to be viable alternatives. Thus, there is still a commercial need for improved blue-emitting, VUV-excited phosphors with reduced degradation characteristics. In particular, the following properties would be desirable: a deeper blue color, improved color stability during panel manufacture, improved lifetime during panel operation, and a high relative percent maintenance of the I/y ratio after accelerated thermal, humidity, Xe plasma, and high intensity VUV photon flux testing.

### SUMMARY OF THE INVENTION

Recently, it has been discovered that an europium-activated, calcium-substituted barium hexa-aluminate (CBAL) phosphor can be used in VUV-excited devices as an acceptable blue-emitting phosphor without suffering the degradation exhibited by BAM phosphors. CBAL phosphors have been previously described as a conventional fluorescent phosphor in U.S. Pat. No. 4,827,187, for use with mercury vapor discharges, but have not heretofore been described for use in VUV-excited devices. Preferably, the CBAL phosphor has a composition represented by the formula Ba_{1.29-x-y}CaₓEu_{y}Al₁₂O_{19.29}, wherein 0<x<0.25 and 0.01<y<0.20.

Under VUV excitation, CBAL phosphors exhibit a deeper blue emission peak than BAM phosphors, but with only 80-85% the initial intensity of a commercially available BAM phosphor. However, upon exposure to elevated temperature and humidity conditions, CBAL phosphors exhibit very nearly zero green shift in the color point and very little loss of intensity. Furthermore, upon exposure to a high intensity VUV photon flux used as an accelerated aging test, the CBAL phosphor exhibits less than ½ the intensity degradation found in a commercial BAM phosphor and very nearly no color shift.

We have found that certain maintenance characteristics of the CBAL phosphor, and other VUV phosphors, may be significantly improved by coating the individual phosphor particles with an aluminum oxyhydroxide coating applied via a chemical vapor deposition (CVD) technique in a fluidized bed reactor. The novel method uses a reaction between vaporized trimethylaluminum (IMA) and water vapor. Such TMA/water reactions have been previously described for use in coating primarily zinc sulfide-based electroluminescent phosphors, e.g., U.S. Pat. Nos. 5,080,928 and 5,220,243. However, in the method of this invention, the TMA/water reaction is conducted at a much higher temperature, about 430° C. or above, than indicated by the above prior art, 300° C. or less. Applying the TMA/water reaction on VUV-excited phosphors at 180° C., typical for ZnS electroluminescent phosphors, doesn't result in any significant protection for VUV phosphors from moisture attack. The coating deposited under the low temperature conditions is believed to be insufficiently dense to prevent the penetration of water molecules. Thus, the higher temperature condition is required to impart the improved maintenance characteristics.

### BRIEF DESCRIPTION OF THE DRAWING

The FIGURE is an illustration of an apparatus used in the method of this invention.

### DETAILED DESCRIPTION OF THE INVENTION

For a better understanding of the present invention, together with other and further objects, advantages and capabilities thereof, reference is made to the following disclosure and appended claims taken in conjunction with the above-described drawing.

Many encapsulation methods, which employ chemical vapor deposition in a fluid bed reactor have been disclosed to protect phosphor particles from degradation. However, the small-size (3 to 5 um, D50 size) blue phosphors for plasma display panels (PDP), such as BAM and CBAL are very difficult to fluidize due to their cohesive characteristics. Also, the Eu⁺² activator in these phosphors is very easy to oxidize under an oxidative environment. The method of this invention is a hydrolysis process which can be used to encapsulate oxidation sensitive, and other, VUV-excited phosphors. The water vapor is used not only to react with other reactant to form the coatings but also to help the fluidization of fine-size phosphor particles. The method applies a chemical vapor deposition technique to deposit a thin film of an hydrolyzed trimethylaluminum compound on individual particles of phosphor powders. Although the composition of the hydrolyzed trimethylaluminum compound can be somewhat difficult to determine, it can be fairly described as an aluminum oxyhydroxide. During the coating process, the particles are suspended in a fluidized bed and exposed to the vaporized trimethylaluminum precursor in an inert carrier gas at a bed temperature of about 430° C. or above. Also, the inert gas, typically nitrogen, is passed through a heated water bubbler to carry the water vapor into the reactor. The gaseous water molecules then react with the trimethylaluminum vapor to form a continuous coating on the surface of phosphor powders. It has been found that the coating deposited on PDP phosphors under the high temperature conditions significantly improves the humidity resistance of the phosphors. To demonstrate the effectiveness of coating, phosphors were encapsulated by this high-temperature hydrolysis coating process and then tested under various conditions.

Coating Procedure

All the coating tests were conducted in a quartz reactor tube with a 14 cm inside diameter and a length of 152 cm. Referring to the FIGURE, for each run, a 4.0 kg quantity of phosphor 60 was charged into reactor 16. An inert nitrogen fluidizing gas 5 at 15 liter per minute was first introduced into the bottom of the reactor 16 to fluidize the phosphor particles. The phosphor particles were suspended by the nitrogen gas in the fluidized bed reactor and to a bed height of about 100 cm. A vibromixer 19 inserted through the top of the reactor 16 was then turned on at a speed of 60 cycles/minute to help the circulation of phosphor particles inside the reactor. The fluidized bed reactor was heated and maintained at a temperature of approximately 430° C. by external furnace 20. Two thermocouples were placed inside the reactor to monitor the temperature profile of the bed. One located in the middle of bed was used to control the reactor temperature within ±5° C. during the coating process. The other thermocouple is placed one inch above the distributor 33, which is located on the bottom of the reactor. When the reactor temperature approached to 430° C., a TMA pre-treatment step was initiated. A nitrogen carrier gas 11 flowed through the trimethylaluminum bubbler 12 at 8.0 liter/minute. The TMA bubbler 12 was kept at the temperature of 34° C. to maintain the constant TMA vapor pressure. Nitrogen gas stream 13 containing the vaporized trimethylaluminum precursor was mixed with the 15.0 liter/minute nitrogen fluidizing gas stream 5 and flowed into the base of the fluidized bed reactor. This dilute trimethylaluminum precursor vapor passed through metal frit distributor 33 located under the tube reactor and used to support the phosphor particle bed. After the surfaces of phosphor powders were saturated with TMA precursor for one minute, water vapor was transported into the reactor via a third stream of nitrogen gas 23 with the flow rate of 14 liter/minute. A nitrogen carrier gas stream 17 was passed through a water-filled bubbler 22 which is maintained at the temperature of 70° C. The water vapor and nitrogen mixture 23 was flowed into the reactor through a series of fine holes circumferentially located on the hollow shaft 7 of vibromixer 19 above the vibrating disc 3 to start the coating process. The coating reaction was allowed to proceed until the desired quantity of hydrolyzed TMA coating had been produced.

Thermal humidity and accelerated aging tests were designed to simulate actual PDP panel manufacturing and operation. Brightness before and after the thermal humidity and accelerated aging tests were obtained by measuring emission spectra using a Perkin-Elmer LS-50B spectrometer and quantifying them relative to the emission spectrum of a standard BAM phosphor reference. The peak wavelengths at maximum intensity were derived from the spectra and the y coordinate color values were calculated from the spectral data using well-known and accepted equations based on X, Y, Z-tristimulus curves. The excitation source is a commercially available xenon excimer lamp (XeCM-L from Resonance, Ltd., Barrie, Ontario, Canada) used to illuminate powder plaques while excluding air from the VUV beam path. The phosphor can also be mixed into a paste, coated onto alumina chips or “slides”, and measured in this fashion.

The thermal humidity test involves exposing phosphor samples to a warm, water-saturated air flow at 425° C. for 2 hours. The accelerated aging test involves exposure to a high intensity Xe plasma and VUV photon flux. The accelerated aging test is performed using a high-power rare-gas discharge chamber. The chamber consists of a 100 cm loop of 5 cm I.D. Pyrex™ tubing that has approximately 5 millitorr of flowing Xe after an initial evacuation to a 10⁻⁶ torr. An inductively coupled discharge is obtained after applying approximately 280 watts of input power at 450 kHz from an RF power supply. It is estimated that there is approximately 90 milliwatts/cm² of 147 nm VUV radiation at the sample surface. No significant excimer emission is generated under these conditions. After a selected amount of time exposed to the Xe discharge, the samples were measured for brightness as described above.

### EXAMPLE 1

Samples of CBAL and a high-temperature hydrolyzed TMA-coated CBAL (cCBAL) were prepared and their emission spectra collected The samples were then subjected to degradation testing as described above. The application of the high-temperature hydrolyzed TMA coating significantly improves the maintenance characteristics of CBAL phosphor. The optical emission results for the initial and degraded CBAL and cCBAL phosphors are provided below in Table 1 (compared to a standard BAM phosphor used as a control). The term “TH” denotes samples that have been degraded by exposure to elevated temperature and humidity; the term “X” denotes samples degraded by exposure to high intensity Xe plasma and VUV photon flux; and the term “THX” denotes samples degraded by exposure to elevated temperature and humidity followed by exposure to high intensity Xe plasma and VUV photon flux. Intensities were measured relative to a standard blue-emitting PDP BAM phosphor.

TABLE 1

| | Powder Plaque Data | | | Paste Slide Data | | |
|---|---|---|---|---|---|---|
| | BAM | | | BAM | | |
| | (control) | CBAL | cCBAL | (control) | CBAL | cCBAL |
| Intensity | 96% | 76% | 68% | 104% | 84% | 79% |
| (initial) | | | | | | |
| Peak λ | 446 | 439 | 439 | 446 | 439 | 439 |
| (initial) | nm | nm | nm | nm | nm | nm |
| y value | 0.0465 | 0.0568 | 0.0553 | 0.0466 | 0.0518 | 0.0517 |
| (initial) | | | | | | |
| Intensity | 87% | 74% | 69% | 96% | 82% | 79% |
| (TH) | | | | | | |
| Peak λ | 456 | 439 | 439 | 456 | 439 | 439 |
| (TH) | nm | nm | nm | nm | nm | nm |
| y value | 0.0803 | 0.0571 | 0.0566 | 0.0771 | 0.0527 | 0.0542 |
| (TH) | | | | | | |
| % I/y | 52% | 96% | 98% | 56% | 96% | 95% |
| (TH) | | | | | | |
| Intensity | 57% | 42% | 49% | 76% | 61% | 66% |
| (X) | | | | | | |
| Peak λ | 446 | 439 | 439 | 446 | 439 | 439 |
| (X) | nm | nm | nm | nm | nm | nm |
| y value | 0.0527 | 0.0625 | 0.0608 | 0.0504 | 0.0565 | 0.0563 |
| (X) | | | | | | |
| % I/y | 53% | 50% | 65% | 68% | 66% | 76% |
| (X) | | | | | | |
| Intensity | 52% | 47% | 49% | 64% | 60% | 65% |
| (THX) | | | | | | |
| Peak λ | 454 | 439 | 439 | 454 | 439 | 439 |
| (THX) | nm | nm | nm | nm | nm | nm |
| y value | 0.0901 | 0.0642 | 0.0633 | 0.0905 | 0.0596 | 0.0602 |
| (THX) | | | | | | |
| % I/y | 28% | 54% | 63% | 32% | 62% | 70% |
| (THX) | | | | | | |

The degradation results from powder and paste samples are similar. The peak wavelength at maximum intensity does not change for either the CBAL or cCBAL samples while the BAM control sample shows a large shift in color after the thermal humidity test The initial brightness for the BAM control is much higher than the initial brightness of the CBAL and cCBAL samples, while after exposure to the thermal humidity test and the high intensity Xe plasma and VUV photon flux, all samples have comparable brightness. The maintenance of the I/y ratio (%I/y) for the CBAL sample after thermal humidity and Xe plasma testing (THX) is vastly superior to that of the BAM control (54% vs. 28% and 62% vs. 32%) and the maintenance of coated CBAL (cCBAL) is further improved to that of uncoated CBAL (63% vs. 54% and 70% vs. 62%). The cCBAL material also exhibits significantly improved maintenance after high intensity Xe plasma and VUV photon flux exposure alone (X).

### EXAMPLE 2

Manganese-activated zinc silicate (Zn₂SiO₄:Mn) is an efficient green-emitting phosphor for plasma display panels. This phosphor is very stable during the PDP panel manufacturing process. No significant brightness degradation and color shift are observed following exposure to the elevated temperature and humidity. However, the degradation of phosphor brightness is significant under the ion bombardment and VUV radiation from the plasma. To improve the brightness maintenance, a Zn₂SiO₄:Mn phosphor (OSRAM SYLVANIA Type 9310) was coated with an aluminum oxyhydroxide coating according to the method of this invention. In order to compare the effectiveness of hydrolyzed TMA coatings under the accelerated aging test, phosphor powders were encapsulated at both low (180° C.) and high (430° C.) reaction temperatures. The uncoated and coated phosphors were mixed with paste and the binder burnt out (BBO). The initial brightness (after BBO), and final brightness (after exposure to a high intensity Xe plasma and VUV photon flux) were measured and the maintenance (ratio of final brightness/initial brightness) calculated. The results of these measurements are provided in Table 2.

TABLE 2

| | Initial Brightness, | Final Brightness, | Maintenance, |
|---|---|---|---|
| Sample | % | % | % |
| Uncoated | 100 | 74.8 | 74.8 |
| Coated at 180° C. | 84.8 | 62.8 | 74.0 |
| Coated at 430° C. | 80.7 | 69.5 | 86.0 |

Based on the data shown in table 2, no enhancement of brightness maintenance was observed when the phosphor was encapsulated by using the hydrolysis reaction of TMA at 180° C. However, the brightness maintenance was improved significantly from 74.8% to 86.0% when the hydrolyzed TMA coating was deposited on phosphor surface at the temperature of 430° C.

While there has been shown and described what are at the present considered the preferred embodiments of the invention, it will be obvious to those skilled in the art that various changes and modifications may be made therein without departing from the scope of the invention as defined by the appended claims.

We claim:

1. A method of encapsulating phosphors comprising:
(a) fluidizing phosphor particles in a fluidized bed reactor;
(b) exposing the particles to vaporized trimethylaluminum;
(c) reacting water vapor the trimethylaluminum at a temperature of about 430° C. or above to form a coating of a hydrolyzed trimethylaluminum compound on the phosphor particles.

2. The method of claim 1 wherein the phosphor particles comprise an europium-activated, calcium-substituted barium hexa-aluminate phosphor.

3. The method of claim 1 wherein the phosphor particles comprises a manganese-activated zinc silicate phosphor.

4. The method of claim 2 wherein the reaction occurs at about 430° C.

5. The method of claim 3 wherein the reaction occurs at about 430° C.

6. The method of claim 2 wherein the europium-activated, calcium-substituted barium hexa-aluminate phosphor has a composition represented by the formula Ba_{1.29-x-y}CaₓEu_{y}Al₁₂O_{19.29}, wherein 0<x<0.25 and 0.01<y<0.20.

7. The method of claim 6 wherein the reaction occurs at about 430° C.

8. A phosphor encapsulated according to the method of claim 1 wherein the phosphor is an europium-activated, calcium-substituted barium hexa-aluminate phosphor.

9. The phosphor of claim 8 wherein the europium-activated, calcium-substituted barium hexa-aluminate phosphor has a composition represented by the formula Ba_{1.29-x-y}CaₓEu_{y}Al_{19.29}, wherein 0<x<0.25 and 0.01<y<0.20.

10. A phosphor encapsulated according to the method of claim 1 wherein the phosphor is a manganese-activated zinc silicate phosphor.
